(19) United States
(12) Patent Application Publication
(10) Pub. No.: US 2008/0104211 A1
(43) Pub. Date: May 1, 2008

(54) REMOTELY-CONTROLLED IMAGING SYSTEM

(76) Inventor: Marcus Blumenfeld, Webster, NY (US)

Correspondence Address: HISCOCK & BARCLAY, LLP, 2000 HSBC PLAZA, 100 Chestnut Street, ROCHESTER, NY, 14604-2404, US

(21) Appl. No.: 11/780,117

(22) Filed: Jul. 19, 2007

Related U.S. Application Data
(60) Provisional application No. 60/832,352, filed on Jul. 20, 2006.

(51) Int. Cl. G06F 15/177

(52) U.S. Cl. 709/221

(57) ABSTRACT

A remotely-controlled imaging system for capturing and transmitting images and videos from an image capturing device to a Web portal on the World Wide Web. The Web portal is capable of storing, organizing and presenting those images and videos to Web users. The image capture device's operating parameters may be remotely-modified by a software program residing at the Web portal.

### CROSS-REFERENCE TO RELATED APPLICATIONS

This application claims priority from U.S. Provisional Patent Application Ser. No. 60/832,352 filed Jul. 20, 2006.

### FIELD OF THE INVENTION

This invention relates to a remotely-controlled imaging system for the capture, retention, and presentation of images and video, and more specifically to the capture, retention, and presentation of said images using a wireless image capturing device controlled using a Web portal on the World Wide Web.

### BACKGROUND OF THE INVENTION

Webcams are cameras that feed their outputs to sites on the World Wide Web. Webcams serve as a conventional means of obtaining images and videos from remote sites and presenting those images and videos to users of the World Wide Web via a Website accessible to the public or to licensed or approved users. In addition, certain Websites providing access to such Webcams may offer Website users the opportunity to submit commands to a Webcam to change its operating parameters such as direction of view, focus, zoom, position, frequency or rate of image acquisition, or type of image acquisition, such as still images or streaming video.

A Webcam requires a power source and a connection to the World Wide Web to display images taken from the Webcam on the Websites. In areas where power and a connection to the World Wide Web are not readily available installing new lines and equipment are necessary for the Webcam to function properly. This becomes even more problematic if the Webcam requires movement to a new area.

Therefore, there is a need for an easily movable image capturing device that can be controlled from a remote location.

### SUMMARY OF THE INVENTION

The invention integrates image capturing and Internet access capabilities with a World Wide Web portal in a single device. The image capturing device is independently powered and is wirelessly connected to the Internet. A storage subsystem in the image capturing device retains any images or videos captured by the camera. The images or videos are uploaded to the invention's Web portal under the control of a portal user. The operation of the camera may be modified by the Web portal user remotely without the need to physically contact the image capturing device.

The Web portal provides a plurality of web pages to modify and control the images capturing device. The Web portal also provides options for the portal user to organize and display selected images on the World Wide Web.

### BRIEF DESCRIPTION OF THE DRAWINGS

FIG. 1 shows the overview of the invention's integration of its components;

FIGS. 2A through 2B show a schematic view of various designs for the image capturing device according to the present invention;

FIG. 3 shows a schematic view of the internal components of the image capturing device according to the present invention;

FIG. 4 shows a diagram for simple network according to the present invention;

FIG. 5 shows a diagram for web portal access according to the present invention;

FIG. 6 shows a network diagram according to the present invention;

FIG. 7 shows a flow chart for the first software program according to the present invention;

FIG. 8 shows a flow chart for the second software program according to the present invention;

FIG. 9 shows a flow chart for the third software program according to the present invention;

FIG. 10 shows a flow chart for the fourth software program according to the present invention;

FIG. 11 shows a flow chart for the fifth software program according to the present invention;

FIG. 12 displays typical data fields available on an image capture device control page on the Web portal according to the present invention;

FIG. 13 displays an image control page on the web portal according to the present invention; and

FIG. 14 displays a public image display page according to the present invention.

### DETAILED DESCRIPTION OF THE INVENTION

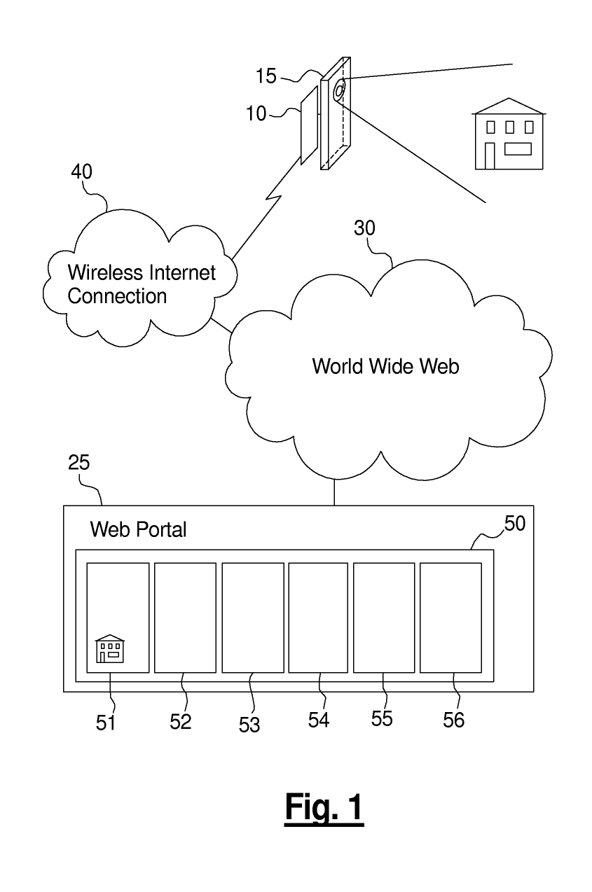

Referring to FIG. 1, the image capturing device 10 is capable of capturing images and transmitting those images through a wireless internet connection 40 to a Web portal 25 on the World Wide Web 30. The Web portal 25 is interactive and has a plurality of Web pages 50 to provide various features.

The image control page 51 allows for the portal user to publicly or privately display one or more pages for images, video and archived images from a specific image capturing device 10. The portal user can set security settings and access privileges for the image display page 53. The portal user can select which images they wish to display and how frequently, if at all, they update. It is understood that the term images refers both to still images and video.

The image capturing device control page 52 is one or more Web pages that allow the portal user to control a particular image capturing device. The portal user may modify the image capturing device's operating parameters from the image capturing device control page 52. The portal user may also control options for the image display page 53 such as manage personal content, picks the themes, colors, styles, folders, settings made for public or private viewing of the pages.

The image display page 53 is one or more Web pages where images are displayed. All public images from all portal users may be displayed in one or more pages. Private images may be stored on one or more pages that require access to a Web user prior to displaying the images.

Additional Web pages include the features of allowing a user to grant authorization to other users or non-users to view particular images; giving a user access to account information; and providing online help to a user.

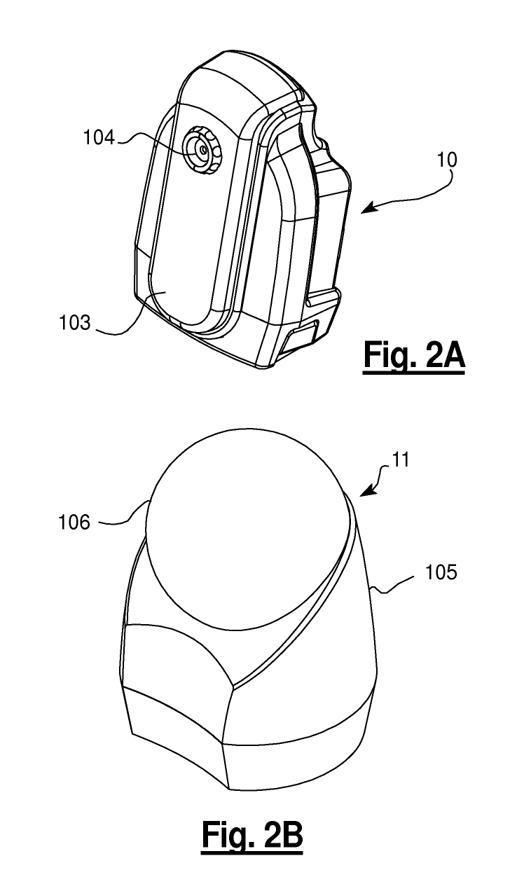

Referring to FIG. 2A, there is shown one design of an image capturing device 10. The camera (not shown) is internal to the casing 103 and is capable of capturing images through the translucent area 104. Referring to FIG. 2B, there is shown an alternative design of an image capturing device 102. The camera (not shown) is internal to the casing 105 and is capable of capturing images through the translucent area 106.

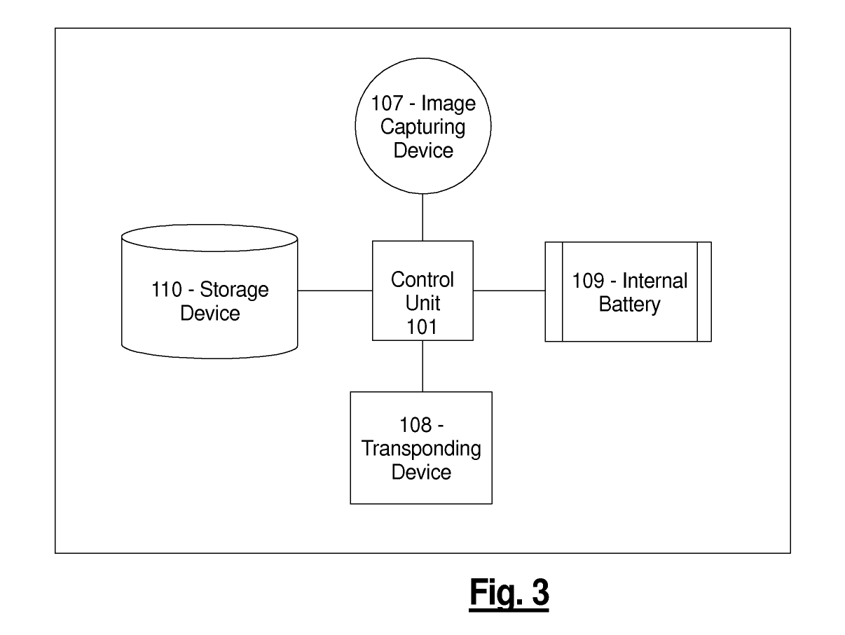

The camera 107 (as shown in FIG. 3) is positioned within the image capture device 11 such that the camera 107 can capture images through the translucent area 104. In one embodiment the camera 107 is positioned within a weatherproof compartment. In one embodiment the camera has a resolution of at least 1.0 megapixels. In another alternative embodiment the camera has a resolution of at least 2.0 megapixels.

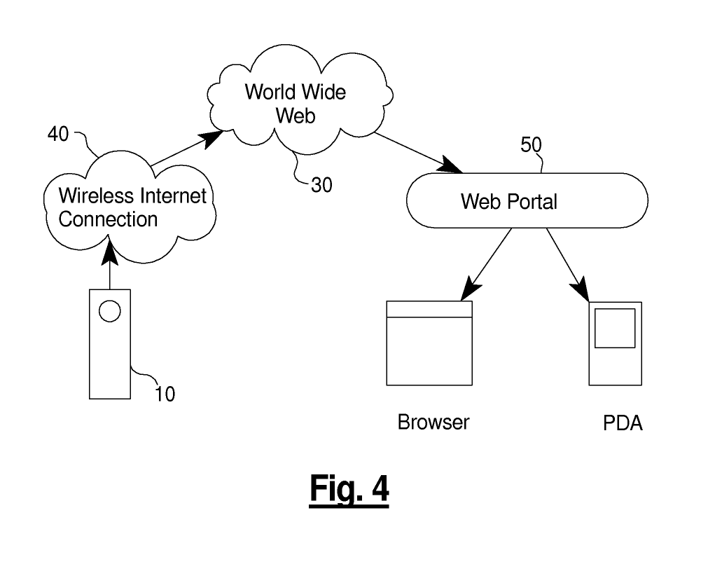

Referring to FIGS. 3-4, the control unit 101 contains a microprocessor and memory. The control unit 101 can access and transmit data to the various components within the image capture device 10. The control unit 101 sends and receives image information to and from the storage device 110 operating parameters to and from the storage device 110, status information from the internal battery 109, command and image information to an from the transponding device, image files from the camera 107, camera operating parameters to and from the camera 107, and status information from the camera 107. It is understood that additional components can be within the image capture device 10 without departing from the scope of the current invention. Additionally, the control unit 101 can send and receive additional operating parameters to components within the image capture device 10.

A storage device 110 is connected to the camera 107 for storing images. The storage device may be a solid state drive or a flash memory device. In one embodiment the storage device has a storage capacity of at least 256 MB. In another embodiment the storage device has a storage capacity of at least 1 GB.

An internal battery 109 supplies power for the image capturing device 10. In one embodiment the battery is rechargeable and has a storage capacity of at least 2 amp hours. In another embodiment the battery is rechargeable and has a storage capacity of at least 5 amp hours.

The transponding device 108 transmits images from the image capturing device 10 to the Web portal 50 through the wireless Internet connection 40. The transponding device 108 receives information from the Web portal 50 to modify the image capturing device's operating parameters. In one embodiment the transponding device 108 connects to the wireless Internet connection 40 through cellular network, such as the public switched telephone network. In an alternative embodiment the transponding device 108 connects to the wireless Internet connection 40 through Satellite, GSM, EVDO or GPRS technology. In an alternative embodiment the transponding device 108 connects to the wireless internet connection 40 through a wireless radio wave network, such as 802.11, WiMax (802.16-2004[802.16d]), and 802.16c-2005.

The Web portal 40 can be accessed by any Internet ready device. Internet ready devices are known in the art and can include an Internet browser, PDA, or mobile phone.

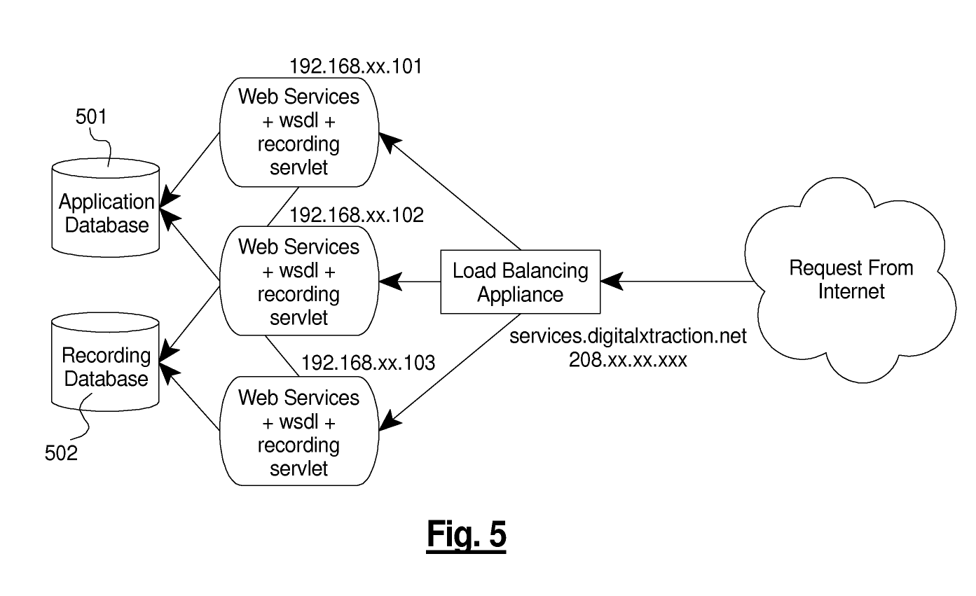

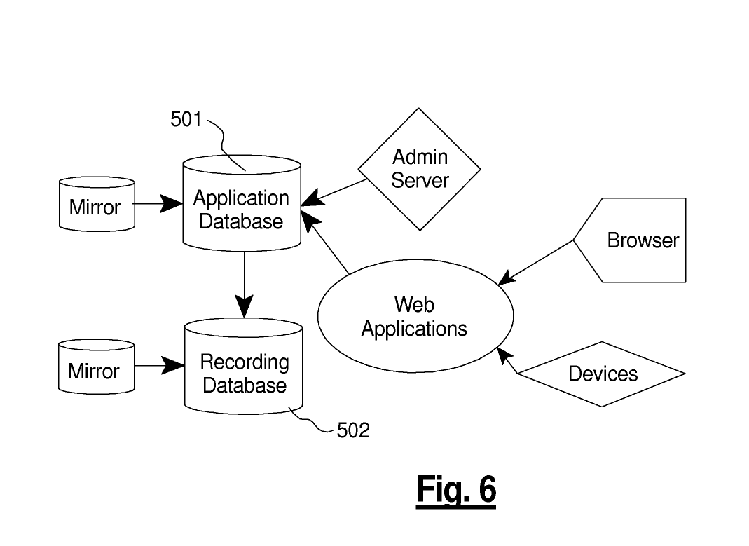

Referring to FIG. 5-6, there is shown access to the Web portal 40. A user accesses the Web portal 40 through an internet connection. Upon authorization the user can access Web pages associated with that user. The Web pages are loaded from the application database 501. The application database 501 can access the recording database 502 and display images, operating parameters, and account information to the Web pages on the Web portal 40.

The image capturing device's operation parameters include, but are not limited to, frequency of image capture, camera positioning, frequency of image transfer, camera zoom, camera resolution, motion sensing parameters, camera power, type of image acquisition, activating or deactivating streaming images, image format, storage format, firmware updates, software updates, device status, battery level, and signal strength.

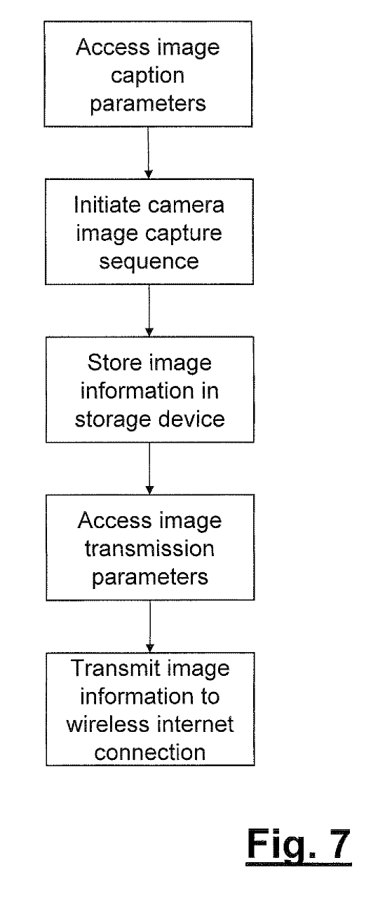

Referring to FIG. 7, there is shown a first software program that resides in the image capturing device 10 to capture images, write captured images to the storage device 110, send images asynchronously via FTP to the Web portal 40.

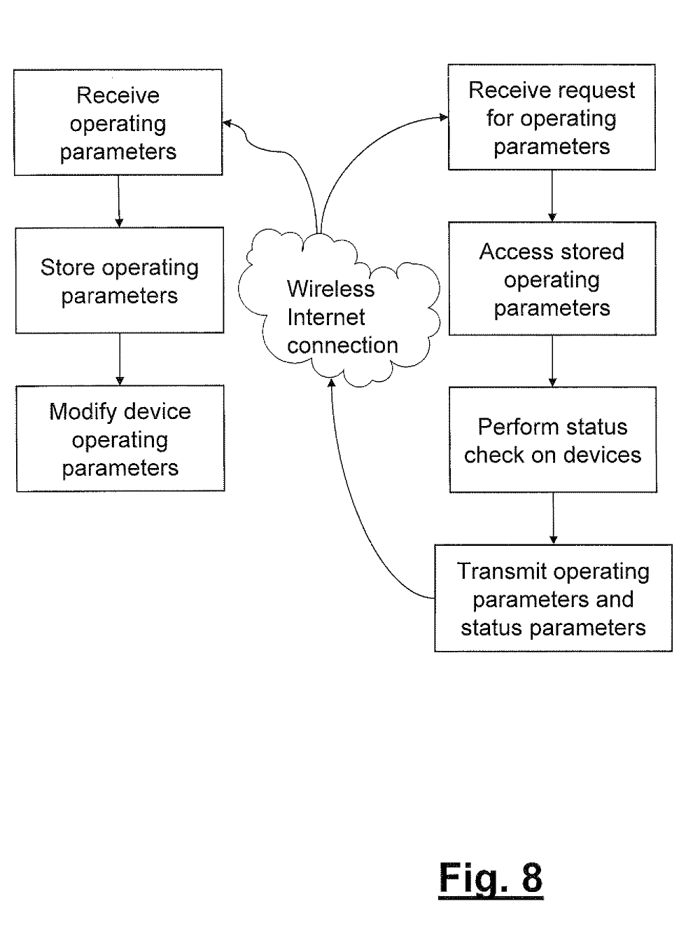

Referring to FIG. 8, there is shown a second software program resides in the image capturing device 10 to control, modify and manage the image capturing device's operating parameters. Additionally, the second software program can access the current status and control parameters of components and transmit that data to the Web portal 40. It is understood that the first and second software programs may be combined into a single program.

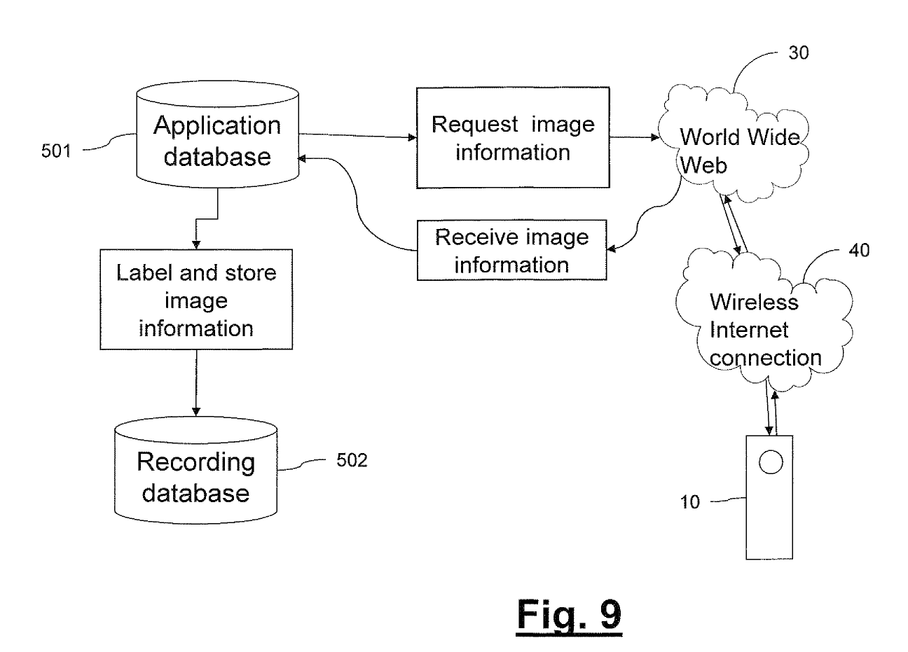

Referring to FIG. 9, there is shown a third software program resides in the application database 501, and is accessible through the Web portal 40, to request and accept images from the first software program. The third software program can store images received from the first software program to the recording database 502. The third software program labels each image file with a unique label and time stamp prior to storing the image in the recording database 502 to prevent overwritten files. In one embodiment, the recording database is at least one dedicated server for archiving and offline viewing. It is understood that a software program residing in the image capturing device 10 can provide label and time stamp information.

Referring to FIG. 10, there is shown a fourth software program resides in the application database 501, and is accessible through the Web portal 40, to accept the portal user's commands to modify the image capturing device 10 operating parameters and relay those commands to the second software program residing in the image capturing device 10.

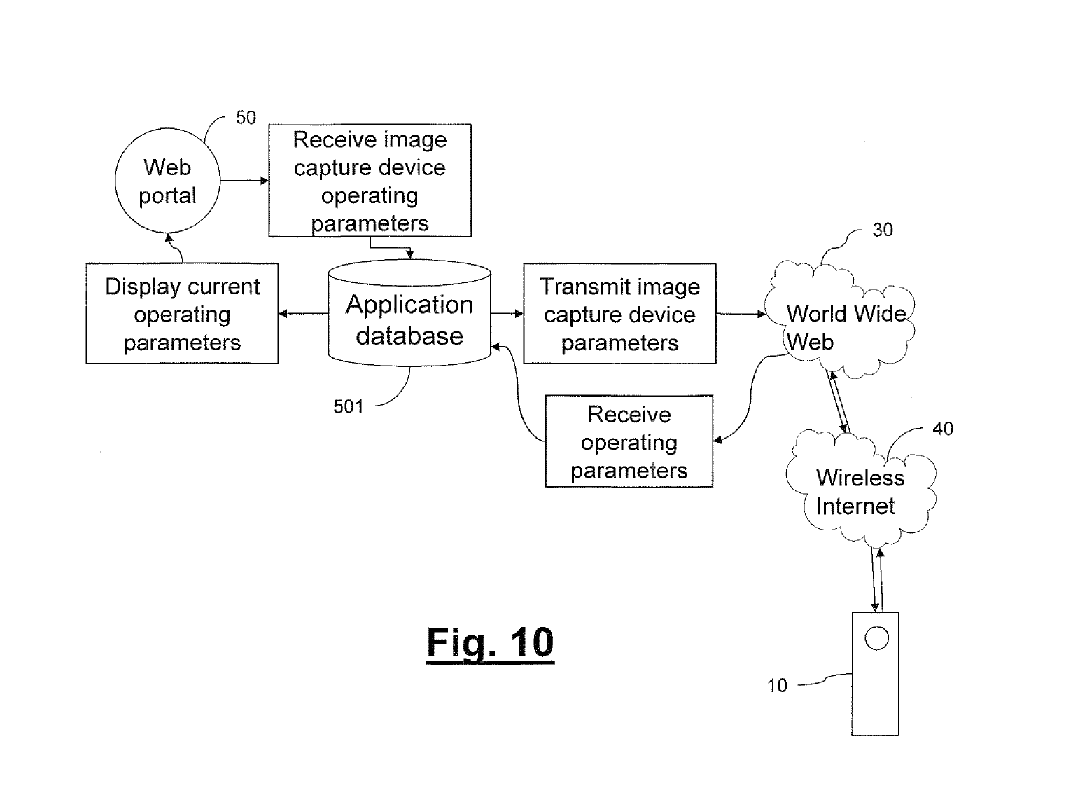

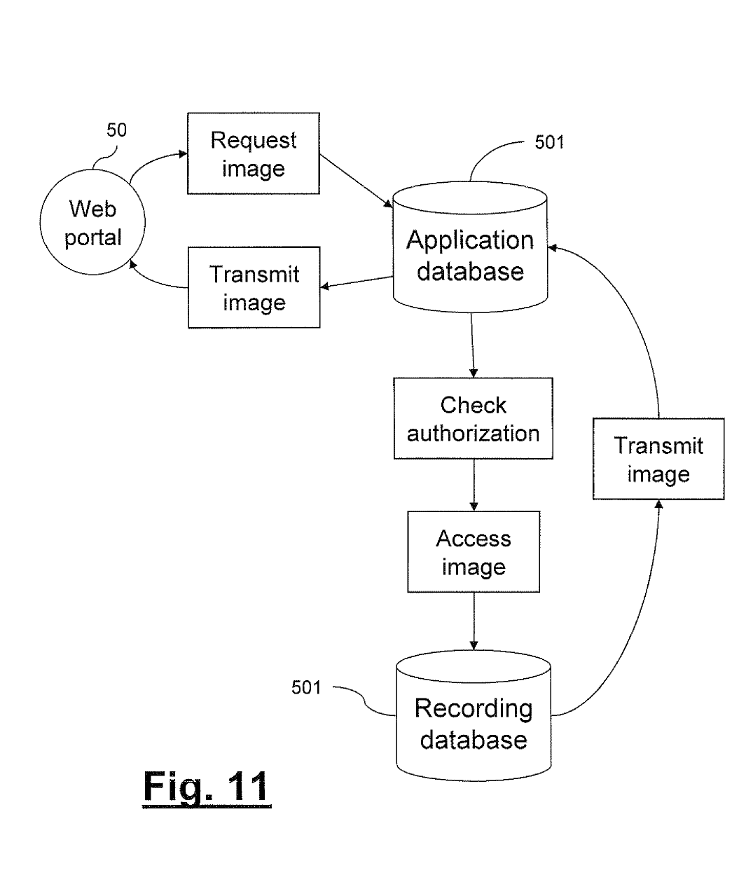

Referring to FIG. 11, there is shown a fifth software program that resides in the application database 501, and is accessible through the Web portal 40, to present images on a set of Web pages to be viewed by Web users. The fifth software program can organize, search for and retrieve images stored by the third software program.

It is understood that the software programs may be written in any combination of computer languages suitable for the application, including, but not limited to C, C++ VBScript, Java, Net, Python, or P4P.

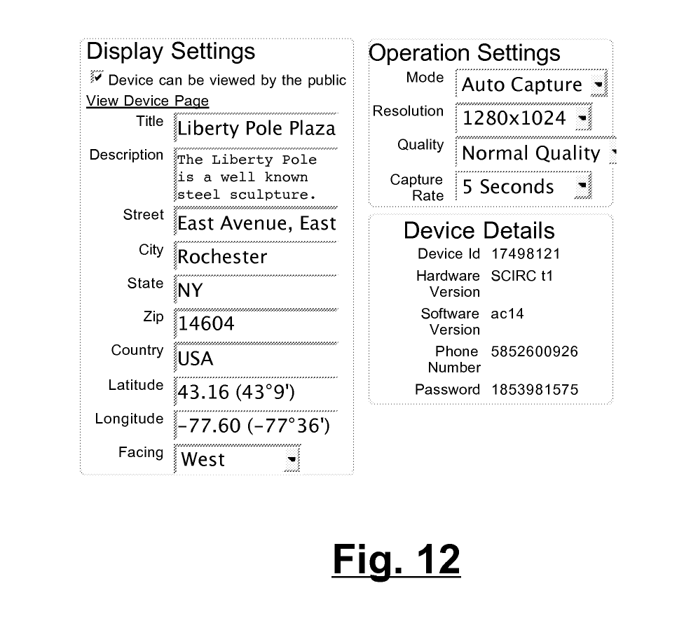

Referring to FIG. 12, there is shown an image capture device control page on the Web portal 40. The control page allows the user to adjust the operating parameters, view the image capture device details, adjust display settings, and view images stored on the recording database 502.

Referring to FIG. 13, there is shown In one embodiment a user has access an image control page on the Web portal 40. The user can view images stored on the recording database 502. Additionally, the user can view the current status of the image capture device 10. The user can access the current camera view and request a still image or video capture.

Referring to FIG. 14, there is shown In one embodiment both a user or non-user has access to a public image display page on the Web portal 40. A user or non-user can access images that they have been authorized to view or public images.

In operation, an image capture device 10 is placed in the vicinity of an object for which it is desirable to capture images of the object. The image capture device 10 may contain a power switch to toggle power on and off. Alternatively, power to the image capture device 10 may be controlled remotely.

A user accesses the Web portal 25 through the World Wide Web 30. The Web portal resides on a secure local server. Once logged into the Web portal 25 the user gains access to the application database. The user has access to all of the image capture devices associated with their account. By selecting the desired image capture device the user has access to set, alter and modify the operating parameters of that image capturing device. The user may set any of the operating parameters, including but not limited to the frequency of image capture, image resolution, and frequency of image transmission. The fourth software program, residing in the application database, accepts the user's commands and stores the information on the local server. The fourth software program then transmits the commands through the World Wide Web 30 and through the appropriate wireless internet connection 40 to the transponding device 108 of the desired image capturing device. The commands are then sent through the transponding device 108 to the second software program residing in the control unit 101 of desired image capturing device. The control unit 101 contains a microprocessor and memory for storage of software programs.

The transponding device 108 provides a wireless connection to the World Wide Web 30 such that the image capturing device and the software programs residing at the application database can communicate. The transponding device 108 may connect to the World Wide Web through cellular networks, satellite, GSM, EVDO, GPRS, or wireless radio wave networks.

The second software program, residing in the image capture device, performs each desired command requested by the user and transmitted by the fourth software program. The commands can modify any of the operating parameters for the image capture device. It is understood that the control unit 101 may be a singe control unit or a plurality of control units linked by a control interface. The second software program accesses the appropriate component within the image capturing device and adjusts the operating parameters accordingly. Additionally, the second software program can access status information pertaining to the various components contained within the image capturing device. For example, the second software program can record storage capacity of the storage device 110, battery life of the internal battery 109, firmware version, connection status, signal strength, power status, image resolution, current zoom level, and pan and tilt parameters. The second software program transmits the status information through the transponding device to the fourth software located at the application database.

The second software program also modifies the operating parameters of the image capturing device as set by the user through the Web portal and transmitted by the fourth software program. For example, the second software program can access the camera and change the resolution for image capture from a low resolution setting to a high resolution setting. The second software program is further capable of managing and deleting information on the storage device, updating firmware, operating pan, tilt, or zoom features, switching the camera from still image to video mode, setting the frequency of image capture, setting the frequency of image transfer, toggling power to the system, adjusting motion sensing, modifying audio features, and adjusting the first software program.

The first software program controls the operation of the camera within the image capturing device. The first software program initiates an image capture from the camera based on the parameters sent by the second software program. The first software program transfers the captured image information to the storage device 110. The image information remains on the storage device until removed by the second software program. The user can set the image information to be deleted once transferred, once manually deleted, or once a retention time parameter expires.

The first software program accesses the storage device and transfers the image information through the transponding device 108 to the third software program residing at the application database. The transmission frequency may be set by the user prior to the transmission. The transmission frequency may be in set for time, number of images, size of new images or any combination thereof. Alternatively, the user may request an instant transmission of stored image information.

The third software program stores the image information on the recording database that is accessible by the Web portal. The user can access the image information through the Web portal. In one embodiment the Web portal allows the user to sort the images by date and time such that the user may view the images based on the time of the image capture.

A fifth software program resides at the recording database and manages image display options. The user accesses the Web portal and sets the image display parameters. The user may set parameters for all images, a group of images or each individual image. The user can chose to keep the image private, public, require an access code, or may select particular users to have access. The fifth software program stores the display information for each image on the recording database. It is understood that the fifth software program may alternatively reside in the application database.

The recording database stores the images for all users. The fifth software program permits the user to access images captured by the image capture devices associated with their account. Additionally, the user can access all of the public images and images that they have received authorization to view. The user can give access to non-users through a Web page on the Web portal. The non-user can then access the display Web page through the World Wide Web to view images designated by the user. The user may set the display Web page as a secure Web page requiring a log on and authentication prior to the non-user viewing any or a portion of the images displayed on the display Web page.

Although the preferred embodiment of the present invention is shown, it will be understood to those skilled in the art that other embodiments can be used without departing from the scope of the invention. For example, while numerous software programs are used it is understood that features of two or more software programs may be combined into a single software program without departing from the scope of the invention.

While this invention has been described as having particular embodiments, the present invention can be further modified within the spirit and scope of this disclosure. This application is therefore intended to cover any variations, uses, or adaptations of the present invention using the general principles disclosed herein. Further, this application is intended to cover such departures from the present disclosure as come within the known or customary practice in the art to which this invention pertains and which fall within the limits of the appended claims.

What is claimed is:

1. A remotely-controlled imaging system comprising:
an image capturing device comprising a camera and a cellular Internet connection;
a Web portal on the World Wide Web in communication with said image capturing device via a cellular connection and the Internet;
a first software program residing in said image capturing device capable of capturing and relaying images from said camera;
a second software program residing in said image capturing device capable of managing and modifying said image capturing device's operating parameters;
a third software program at said Web portal capable of requesting and accepting images from the first software program residing in said image capturing device;
a fourth software program at said Web portal capable of accepting a portal user's commands and relaying said commands to the second software program residing in said image capturing device to modify said image capturing device's operating parameters.

2. The remotely-controlled imaging system of claim 1 wherein said Web portal further comprises a set of Web pages and supporting programs for said Web pages.

3. The remotely-controlled imaging system of claim 2 further comprising a fifth software program at said Web portal capable of presenting images on said Web pages for Web users.

4. The remotely-controlled imaging system of claim 3 wherein said third software program at said Web portal is further capable of storing images from the first software program residing in said image capturing device.

5. The remotely-controlled imaging system of claim 4 wherein said fifth software program at said Web portal is further capable of organizing and retrieving images.

6. The remotely-controlled imaging system of claim 1 further comprising a storage device for storing images and video.

7. T he remotely-controlled imaging system of claim 6 wherein said first software program residing in said image capturing device is further capable of storing images from said camera on said storage device.

8. The remotely-controlled imaging system of claim 7 wherein said first software program is further capable of retrieving and transmitted images stored in the storage device to said Web portal upon request by a Web portal user.

9. The remotely-controlled imaging system of claim 1 wherein the images from the image capture device are streamed immediately to said Web portal.

10. The remotely-controlled imaging system of claim 1 wherein said image capturing device further comprises a battery a rechargeable battery with a storage capacity of at least 2 amp hours.

11. A remotely-controlled imaging system comprising:
an image capturing device comprising a camera and a wireless Internet connection;
a Web portal on the World Wide Web in communication with said image capturing device via a wireless radio wave connection and the Internet;
a first software program residing in said image capturing device capable of capturing and relaying images from said camera;
a second software program residing in said image capturing device capable of managing and modifying said image capturing device's operating parameters;
a third software program at said Web portal capable of requesting and accepting images from the first software program residing in said image capturing device;
a fourth software program at said Web portal capable of accepting a portal user's commands and relaying said commands to the second software program residing in said image capturing device to modify said image capturing device's operating parameters.

12. The remotely-controlled imaging system of claim 11 wherein said Web portal further comprises a set of Web pages and supporting programs for said Web pages.

13. The remotely-controlled imaging system of claim 12 further comprising a fifth software program at said Web portal capable of presenting images on said Web pages for Web users.

14. The remotely-controlled imaging system of claim 13 wherein said third software program at said Web portal is further capable of storing images from the first software program residing in said image capturing device.

15. The remotely-controlled imaging system of claim 14 wherein said fifth software program at said Web portal is further capable of organizing and retrieving images.

16. The remotely-controlled imaging system of claim 11 wherein said image capturing device further comprises a motion sensing device.

17. The remotely-controlled imaging system of claim 11 wherein said image capturing device further comprises a camera with pan, tilt and zoom capabilities.

18. A method for capturing images and wirelessly transmitting said images to a Web portal comprising:
wirelessly transmitting operating parameters via a fourth software program residing in said Web portal capable of accepting a portal user's commands and relaying said commands to a second software program residing in an image capturing device capable of managing and modifying said image capturing device's operating parameters;
capturing an image with an image capturing device comprising a camera, a first software program capable of capturing and relaying images from said camera, and a wireless internet connection;
transmitting an image from said image capturing device via said first software program residing in said image capturing device to a third software program at said Web portal capable of requesting and accepting images from said first software program.

19. The method of claim 18 wherein said image capture device further comprises a storage device for storing images and video.

20. The remotely-controlled imaging system of claim 19 wherein said first software program residing in said image capturing device is further capable of storing images from said camera on said storage device.
